(19) United States
(12) Patent Application Publication
(10) Pub. No.: US 2007/0011136 A1
(43) Pub. Date: Jan. 11, 2007

(54) Employing an identifier for an account of one domain in another domain to facilitate access of data on shared storage media

(75) Inventors: Roger L. Haskin, Morgan Hill, CA (US); Frank B. Schmuck, Campbell, CA (US); Yuri L. Volobuev, Austin, TX (US); James C. Wyllie, Monte Sereno, CA (US)

Correspondence Address: HESLIN ROTHENBERG FARLEY & MESITI P.C., 5 COLUMBIA CIRCLE, ALBANY, NY, 12203, US

(73) Assignee: International Business Machines Corporation, Armonk, NY (US)

(21) Appl. No.: 11/175,076

(22) Filed: Jul. 5, 2005

(51) Int. Cl. G06F 17/30

(52) U.S. Cl. 707/1

(57) ABSTRACT

Access to data stored on shared storage media is facilitated by providing a user with uniform access to the user's data regardless from which administrative domain the user is accessing the data. An identifier for the user is created. The identifier corresponds to one account in one administrative domain, but is used in another administrative domain to access data owned by the user, but managed by the one administrative domain. This allows the user running an application in either administrative domain to access its data with the same permissions.

### CROSS-REFERENCE TO RELATED APPLICATIONS

This application contains subject matter which is related to the subject matter of the following application, which is assigned to the same assignee as this application and is hereby incorporated herein by reference in its entirety:

“DYNAMIC MANAGEMENT OF NODE CLUSTERS TO ENABLE DATA SHARING,” Craft et al., U.S. Ser. No. 10/958,927, filed Oct. 5, 2004.

### TECHNICAL FILED

This invention relates, in general, to data sharing in a communications environment, and in particular, to facilitating access to data stored on shared storage media of the communications environment.

### BACKGROUND OF THE INVENTION

In a communications environment, such as a shared disk cluster file system, data and metadata are stored on shared storage media (e.g., shared disks) accessible by nodes of one or more clusters coupled to the shared disk cluster file system. A node in a cluster accesses data and metadata directly from the shared disks.

A problem arises, however, if the nodes accessing the file system belong to two or more clusters with separately defined user accounts and user identifiers. For example, using technologies, such as fibre channel to internet protocol (FC/IP) routers, it is possible to link the storage area networks (SANs) of clusters at two different locations, A and B, into a single logical SAN, so that nodes from both clusters can directly access file systems stored on disks at either location. In this configuration, a user “John Smith” may have an account in both clusters, but the login name and numerical user id may be different in the two clusters. For instance, in Cluster A, the login name is “John” and the numerical user ID is 409, while in Cluster B, the login name is “J Smith” with a user id of 517. When John Smith creates a file logged in as “John” in Cluster A, user id 409 is recorded as the file owner in the metadata (file inode) stored on shared disk. When John Smith then logs in to a node in Cluster B, the file system does not allow him access to the same file because user id 517 associated with J Smith under which John is logged in Cluster B does not match user id 409 recorded as the file owner on shared disk.

Based on the foregoing, a need exists for a capability that allows a user to access files with the same permissions and access rights in different clusters. For instance, a need exists for an enhancement to the shared disk file system that allows a user uniform access to its files with the same permissions, regardless from which cluster (under which account) the user is accessing the data. In particular, a need exists for a capability that provides an identifier that enables a user to access data from multiple clusters with the same permissions.

### SUMMARY OF THE INVENTION

The shortcomings of the prior art are overcome and additional advantages are provided through the provision of a method of facilitating access to data stored on shared storage media. The method includes, for instance, creating an identifier for a user with a first account in a first administrative domain and a second account in a second administrative domain, the identifier corresponding to the second account in the second administrative domain; and using the identifier in the first administrative domain to access data managed by the second administrative domain, the data being stored on one or more shared storage media directly accessible by the first administrative domain and the second administrative domain.

System and computer program products corresponding to the above-summarized method are also described and claimed herein.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts one example of a cluster configuration, in accordance with an aspect of the present invention;

FIG. 2 depicts one example of an alternate cluster configuration, in accordance with an aspect of the present invention;

FIG. 3 depicts one example of the coupling of a plurality of clusters, in accordance with an aspect of the present invention;

FIG. 4 depicts another example of the coupling of a plurality of clusters, in accordance with an aspect of the present invention;

FIG. 5 depicts one embodiment of the logic associated with accessing data on shared storage media, in accordance with an aspect of the present invention;

FIG. 6 depicts one embodiment of the logic associated with mapping an identifier of one account in one cluster to a corresponding identifier in another cluster, in accordance with an aspect of the present invention;

FIG. 7 depicts one example of the logic associated with a reverse mapping technique used to determine ownership of data, in accordance with an aspect of the present invention;

FIG. 8 depicts one example of mapped identifiers cached in memory of a node of a data using cluster, in accordance with an aspect of the present invention; and

FIG. 9 depicts one embodiment of the logic associated with prefetching a plurality of identifiers, in accordance with an aspect of the present invention.

### BEST MODE FOR CARRYING OUT THE INVENTION

In accordance with an aspect of the present invention, access to data stored on shared storage media is facilitated. The shared storage media is directly accessible by nodes of a plurality of administrative domains (e.g., clusters). Data managed by one administrative domain is accessible by other administrative domains. A user may have accounts on a plurality of administrative domains and wish to access data from each of those domains. To enable consistent access and permission checking, an identifier is created, in accordance with an aspect of the present invention, that enables the user to access data with the same permission checking, regardless of the administrative domain from which the user is accessing the data.

An administrative domain is a grouping of one or more nodes that is maintained independently from other domains. Each domain is maintained separately allowing individual administrative policies to prevail within a particular domain. One example of an administrative domain is a cluster. Although examples are described herein with reference to clusters, one or more aspects of the present invention apply to other administrative domains.

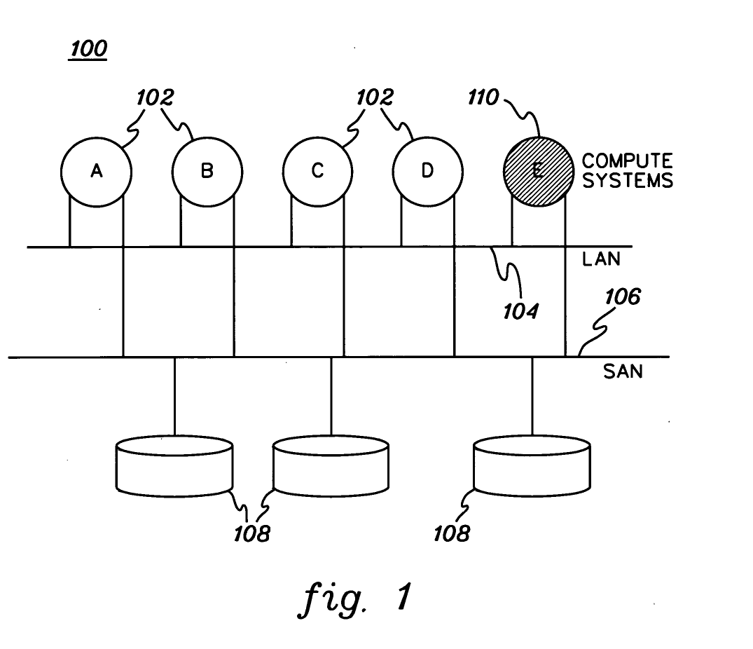

One example of a configuration of an administrative domain is depicted in FIG. 1. In this example, the administrative domain is a cluster. A cluster configuration 100 includes a plurality of nodes 102, such as, for instance, machines, compute nodes, compute systems or other communications nodes. In one specific example, node 102 includes an RS/6000 running an AIX or Linux operating system, offered by International Business Machines Corporation, Armonk, N.Y. The nodes are coupled to one another, via a network, such as a local area network (LAN) 104 or another network in other embodiments.

Nodes 102 are also coupled to a storage area network (SAN) 106, which further couples the nodes to one or more storage media 108. The storage media includes, for instance, disks or other types of storage media. The storage media includes files having data to be accessed. A collection of files is referred to herein as a file system, and there may be one or more file systems in a given cluster. These file systems include the data to be shared by the nodes of the various clusters. In one example, the file systems are the General Parallel File Systems (GPFS), offered by International Business Machines Corporation. One or more aspects of GPFS are described in “GPFS: A Parallel File System,” IBM Publication No. SG24-5165-00 (May 07, 1998), which is hereby incorporated herein by reference in its entirety, and in various patents/publications, including, but not limited to, U.S. Pat. No. 6,708,175 entitled “Program Support For Disk Fencing In A Shared Disk Parallel File System Across Storage Area Network,” Curran et al., issued Mar. 16, 2004; U.S. Pat. No. 6,032,216 entitled “Parallel File System With Method Using Tokens For Locking Modes,” Schmuck et al., issued Feb. 29, 2000; U.S. Pat. No. 6,023,706 entitled “Parallel File System And Method For Multiple Node File Access,” Schmuck et al, issued Feb. 8, 2000; U.S. Pat. No. 6,021,508 entitled “Parallel File System And Method For Independent Metadata Loggin,” Schmuck et al., issued Feb. 1, 2000; U.S. Pat. No. 5,999,976 entitled “Parallel File System And Method With Byte Range API Locking,” Schmuck et al., issued Dec. 7, 1999; U.S. Pat. No. 5,987,477 entitled “Parallel File System And Method For Parallel Write Sharing,” Schmuck et al., issued Nov. 16, 1999; U.S. Pat. No. 5,974,424 entitled “Parallel File System And Method With A Metadata Node,” Schmuck et al., issued Oct. 26, 1999; U.S. Pat. No. 5,963,963 entitled “Parallel File System And Buffer Management Arbitration,” Schmuck et al., issued Oct. 5, 1999; U.S. Pat. No. 5,960,446 entitled “Parallel File System And Method With Allocation Map,” Schmuck et al., issued Sep. 28, 1999; U.S. Pat. No. 5,950,199 entitled “Parallel File System And Method For Granting Byte Range Tokens,” Schmuck et al., issued Sep. 7, 1999; U.S. Pat. No. 5,946,686 entitled “Parallel File System And Method With Quota Allocation,” Schmuck et al., issued Aug. 31, 1999; U.S. Pat. No. 5,940,838 entitled “Parallel File System And Method Anticipating Cache Usage Patterns,” Schmuck et al., issued Aug. 17, 1999; U.S. Pat. No. 5,893,086 entitled “Parallel File System And Method With Extensible Hashing,” Schmuck et al., issued Apr. 6, 1999; U.S. Patent Application Publication No. 20030221124 entitled “File Level Security For A Metadata Controller In A Storage Area Network,” Curran et al., published Nov. 27, 2003; U.S. Patent Application Publication No. 20030220974 entitled “Parallel Metadata Service In Storage Area Network Environment,” Curran et al., published Nov. 27, 2003; U.S. Patent Application Publication No. 20030018785 entitled “Distributed Locking Protocol With Asynchronous Token Prefetch And Relinquish,” Eshel et al., published Jan. 23, 2003; U.S. Patent Application Publication No. 20030018782 entitled “Scalable Memory Management Of Token State For Distributed Lock Managers,” Dixon et al., published Jan. 23, 2003; and U.S. Patent Application Publication No. 20020188590 entitled “Program Support For Disk Fencing In A Shared Disk Parallel File System Across Storage Area Network,” Curran et al., published Dec. 12, 2002, each of which is hereby incorporated herein by reference in its entirety.

Although the use of file systems is described herein, in other embodiments, the data to be shared need not be maintained as file systems. Instead, the data may merely be stored on the storage media or stored as a structure other than a file system.

A file system is managed by a file system manager node 110, which is one of the nodes of the cluster. The same file system manager can manage one or more of the file systems of the cluster or each file system may have its own file system manager or any combination thereof. Also, in a further embodiment, more than one file system manager may be selected to manage a particular file system.

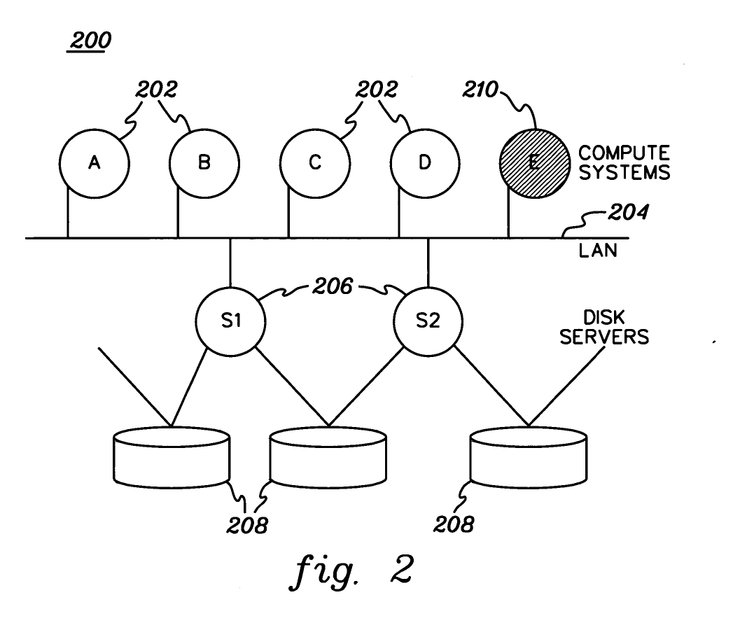

An alternate cluster configuration is depicted in FIG. 2. In this example, a cluster configuration 200 includes a plurality of nodes 202, which are coupled to one another via a local area network 204. The local area network 204 couples nodes 202 to a plurality of servers 206. Servers 206 have a physical connection to one or more storage media 208. Similar to FIG. 1, a node 210 is selected as the file system manager.

The data flow between the server nodes and the communications nodes is the same as addressing the storage media directly, although the performance and/or syntax may be different. As examples, the data flow of FIG. 2 has been implemented by International Business Machines Corporation on the Virtual Shared Disk facility for AIX and the Network Shared Disk facility for AIX and Linux. The Virtual Shared Disk facility is described in, for instance, “GPFS: A Shared-Disk File System for Large Computing Clusters,” Frank Schmuck and Roger Haskin, Proceedings of the Conference on File and Storage Technologies (FAST '02), 28-30, January 2002, Monterey, Calif., pp. 231-244 (USENIX, Berkeley, Calif.); and the Network Shared Disk facility is described in, for instance, “An Introduction to GPFS v 1.3 for Linux-White Paper” (June 2003), available from International Business Machines Corporation (www-1.ibm.com/service/eserver/clusters/whitepapers/gpfs_linux_intro.pdf), each of which is hereby incorporated herein by reference in its entirety.

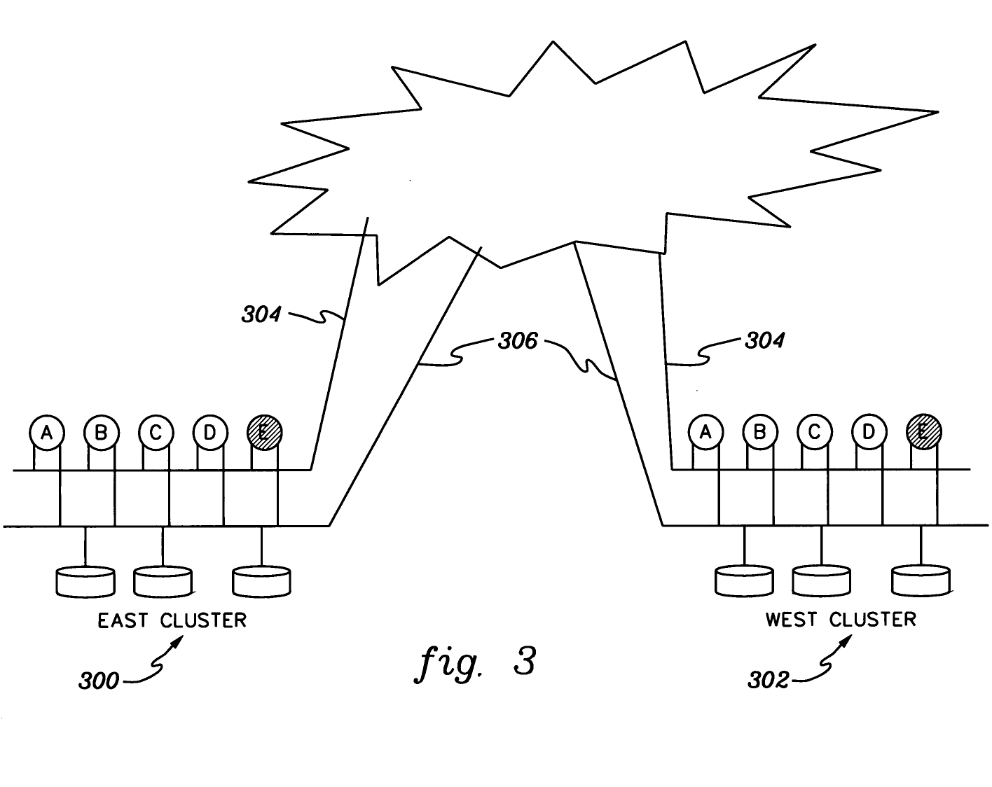

One cluster may be coupled to one or more other clusters, while still maintaining separate administrative and operational domains for each cluster. For instance, as depicted in FIG. 3, one cluster 300, referred to herein as the East cluster, is coupled to another cluster 302, referred to herein as the West cluster. Each of the clusters has data that is local to that cluster, as well as a control path 304 and a data network path 306 to the other cluster. These paths are potentially between geographically separate locations. Although separate data and control network connections are shown, this is only one embodiment. Either a direct connection into the data network or a combined data/storage network with storage servers similar to FIG. 2 is also possible. Many other variations are also possible.

Each of the clusters is maintained separately allowing individual administrative policies to prevail within a particular cluster. This is in contrast to merging the clusters, and thus, the resources of the clusters, creating a single administrative and operational domain. The separate clusters facilitate management and provide greater flexibility.

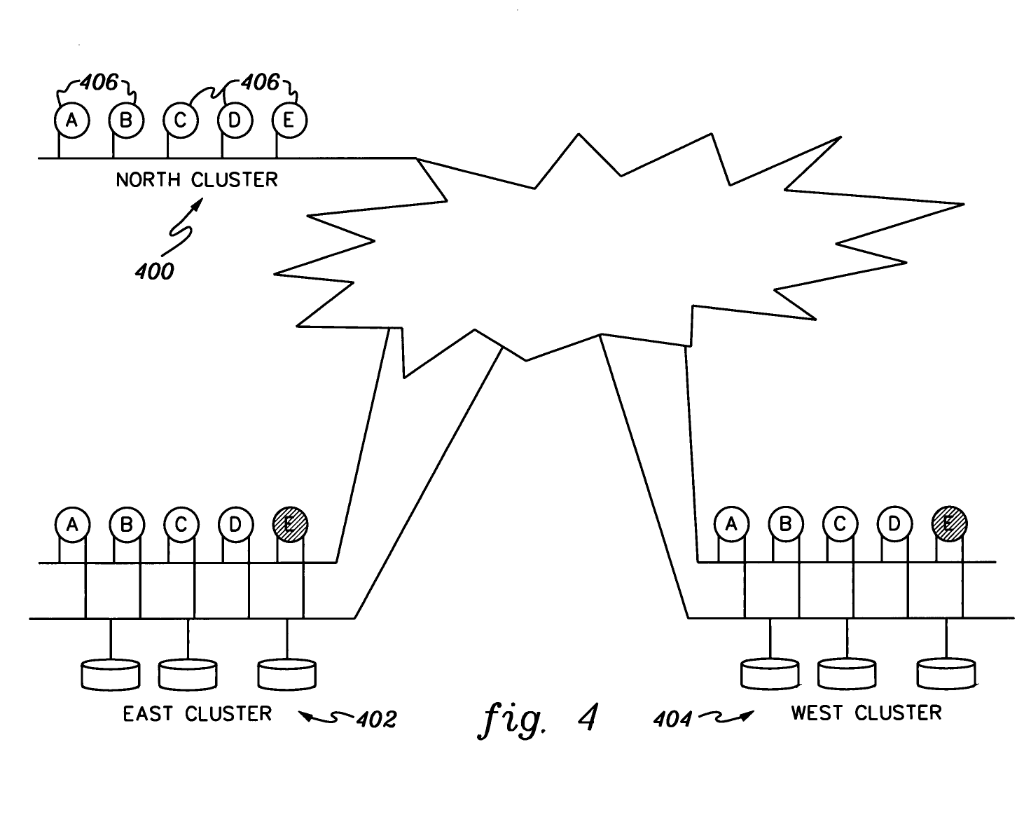

Additional clusters may also be coupled to one another, as depicted in FIG. 4. As shown, a North cluster 400 is coupled to East cluster 402 and West cluster 404. The North cluster, in this example, is not a home cluster to any file system. That is, it does not manage any data. Instead, it is a collection of nodes 406 that can mount file systems from the East or West clusters or both clusters concurrently.

Although in each of the clusters described above five nodes are depicted, this is only one example. Each cluster may include one or more nodes and each cluster may have a different number or the same number of nodes as another cluster.

A cluster may be at least one of a data owning cluster and a data using cluster. A data owning cluster is a collection of nodes, which are typically, but not necessarily, co-located with the storage used for at least one file system owned by the cluster. The data owning cluster controls access to the one or more file systems, performs management functions on the file system(s), controls the locking of the objects which comprise the file system(s) and/or is responsible for a number of other central functions. The data owning cluster is a collection of nodes that share data and have a common management scheme. As one example, the data owning cluster is built out of the nodes of a storage area network, which provides a mechanism for connecting multiple nodes to the same storage media and providing management software therefor.

As one example, a file system owned by the data owning cluster is implemented as a SAN file system, such as a General Parallel File System (GPFS), offered by International Business Machines Corporation, Armonk, N.Y. GPFS is described in, for instance, “GPFS: A Parallel File System,” IBM Publication No. SG24-5165-00 (May 7, 1998), which is hereby incorporated herein by reference in its entirety.

Applications can run on the data owning clusters. Further, the user id space of the owning cluster is the user id space that is native to the file system and stored within the file system.

A data using cluster is a set of one or more nodes which desires access to data managed by one or more data owning clusters. The data using cluster runs applications that use data available from one or more owning clusters. The data using cluster has configuration data available to it directly or through external directory services. This data includes, for instance, a list of file systems which might be available to the nodes of the cluster, a list of contact points within the owning cluster to contact for access to the file systems, and a set of credentials which allow access to the data. In particular, the data using cluster is configured with sufficient information to start the file system code and a way of determining the contact point for each file system that might be desired. The contact points may be defined using an external directory service or be included in a list within a local file system of each node. The data using cluster is also configured with security credentials which allow each node to identify itself to the data owning clusters.

A cluster can concurrently be a data owning cluster for a file system and a data using cluster for other file systems. Just as a data using cluster may access data from multiple data owning clusters, a data owning cluster may serve multiple data using clusters. The configuring of clusters is described in, for instance, a co-pending, commonly assigned U.S. patent application entitled “Dynamic Management Of Node Clusters To Enable Data Sharing”, Craft et al., U.S. Ser. No. 10/958,927, filed Oct. 5, 2004, which is hereby incorporated herein by reference in its entirety.

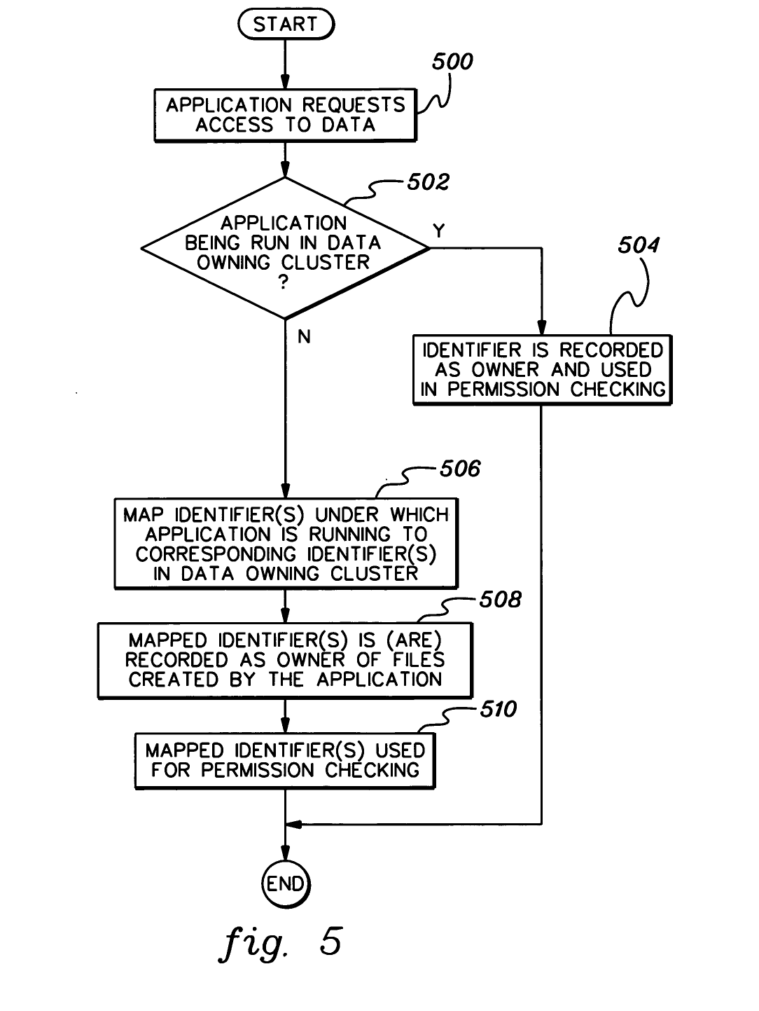

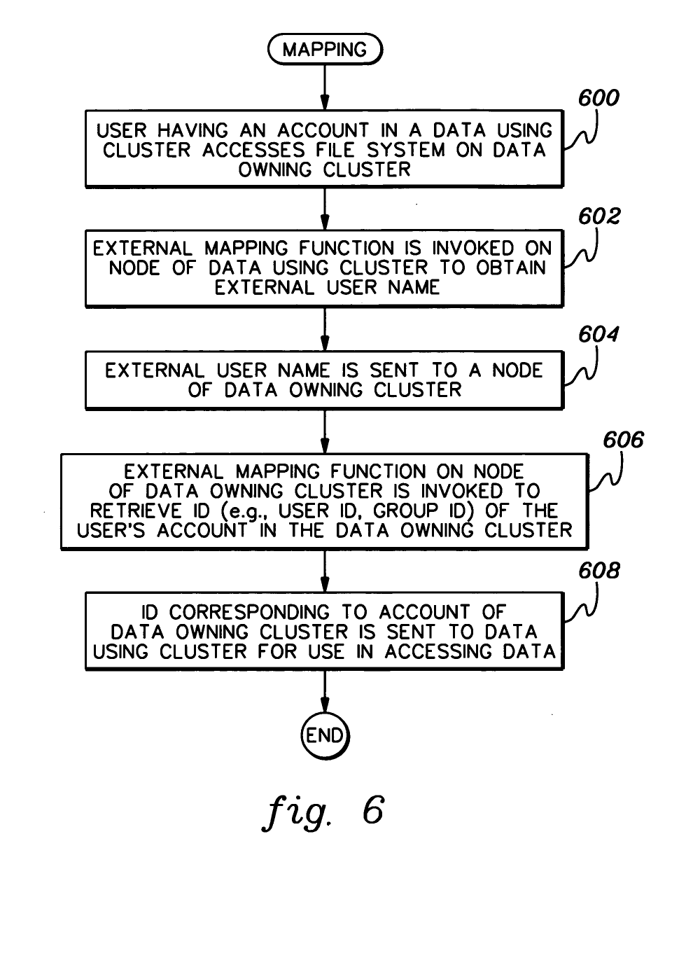

A user of a data using cluster may access data managed by a data owning cluster and stored on storage media directly accessible by both the owning cluster and the using cluster. One embodiment of the logic associated with this processing is described with reference to FIGS. 5 and 6. In particular, FIG. 5 describes one embodiment of the logic associated with accessing data on shared storage media, and FIG. 6 describes further details associated with providing an identifier that facilitates access to data on the shared storage media.

Referring to FIG. 5, initially, a request is made by an application to access data on the shared storage media, STEP 500. If the application is running in a cluster that manages the data (e.g., owns the file system that includes the data), INQUIRY 502, then at least one identifier of the user executing the application is recorded as the owner and used in permission checking, STEP 504. As examples, the at least one identifier includes either a user identifier, one or more group identifiers, or both. A group identifier indicates a group to which the user belongs. The user identifier and/or group identifiers are included in the credentials associated with a user. They appear in metadata on the shared storage media (e.g., disk), as the owner of a file or in access control lists. Both user identifiers and group identifiers have different values in different clusters, and therefore, are mapped, in accordance with an aspect of the present invention, to identifiers that enable consistent permission checking across cluster boundaries.

Returning to INQUIRY 502, if the application requesting access to data on shared storage media is being run in a cluster that is not managing the requested data, referenced herein as a data using cluster, then at least one identifier under which the application is running is mapped to at least one corresponding identifier of the cluster managing that data, referred to herein as the data owning cluster, STEP 506. The manner in which this is accomplished is described in further detail below. The mapped identifier(s) is (are) then recorded as the owner of the data or files created by the application, STEP 508, and is (are) used for permission checking in accessing the data, STEP 510.

The mapping of an identifier is further described with reference to FIG. 6. When the user having an account in the data using cluster first accesses the file system being managed by a data owning cluster, STEP 600, an external mapping function is invoked on a node of the data using cluster to obtain the user's unique external user name, STEP 602. This external user name is a global name understood by the one or more clusters in which the user has accounts. As an example, the external mapping includes placing a file on each node that is to perform translation that includes all the user identifiers of the file system and their corresponding external names. These files are then read to determine the external name.

Products are offered that provide external mapping functions. These products include, for instance, the Enterprise Identity Mapping (EIM) Services offered by International Business Machines Corporation, and the Grid Security Intrastructure (GSI), which is a part of the Globus Toolkit. As an example, EIM comes bundled with certain versions of IBM® operating systems on various platforms, including, but not limited to, AIX 5.2, z/OS V1R4 and os400 release V5R2. Further, it is described in an IBM® white paper entitled “IBM e-Server Enterprise Mapping,” International Business Machines, 2002, available from IBM®, downloadable from http://publib.boulder.ibm.com/infocenter/eserver/vlrl/en_US/index.htm?info/eiminfo/rzalveserverprint.htm, and viewable online at http://publib.boulder.ibm.com/infocenter/eserver/vlrl/en_US/index.htm? info/eiminfo/rzalveservermstl.htm, which is hereby incorporated herein by reference in its entirety. GSI is available as part of the Globus Toolkit offered by Globus (http:// www.globus.org/toolkit/docs/), and is described, for instance, in a paper published in the Proceedings of the 5^{th} ACM Conference on Computer and Communications Security, 1998, San Francisco, Calif., United States, Nov. 02-05, 1998 (also, see, http://portal.acm.org/citation.cfm?id=288090) entitled “A Security Architecture For Computational Grids,” by Ian Foster, Carl Kellelman, Gene Tsudik and Steven Tuecke (Pages 83-92 of the proceedings) (a pre-print version of the paper can be downloaded from http://www-unix.globus.org/ftppub/globus/papers/security.pdf), which is hereby incorporated herein by reference in its entirety.

The external user name is then sent to a node of the data owning cluster, STEP 604. An external mapping function on the node of the data owning cluster is then invoked to retrieve at least one identifier (e.g., user id and/or group id) of the user's account in the data owning cluster, STEP 606. The one or more retrieved identifiers corresponding to the user's account in the data owning cluster are then sent to the data using cluster for use in accessing data, STEP 608. Thus, in accordance with an aspect of the present invention, an identifier that corresponds to an account of one cluster is used by the user having an account in another cluster to access data on the shared storage media.

Advantageously, the mapping between identifiers and external names is accomplished by invoking an external mapping function that can be customized by the administrator. This allows one or more aspects of the invention to be integrated into existing user registration and remote execution infrastructures, such as the global security infrastructure or IBM's Enterprise Identity Mapping Services.

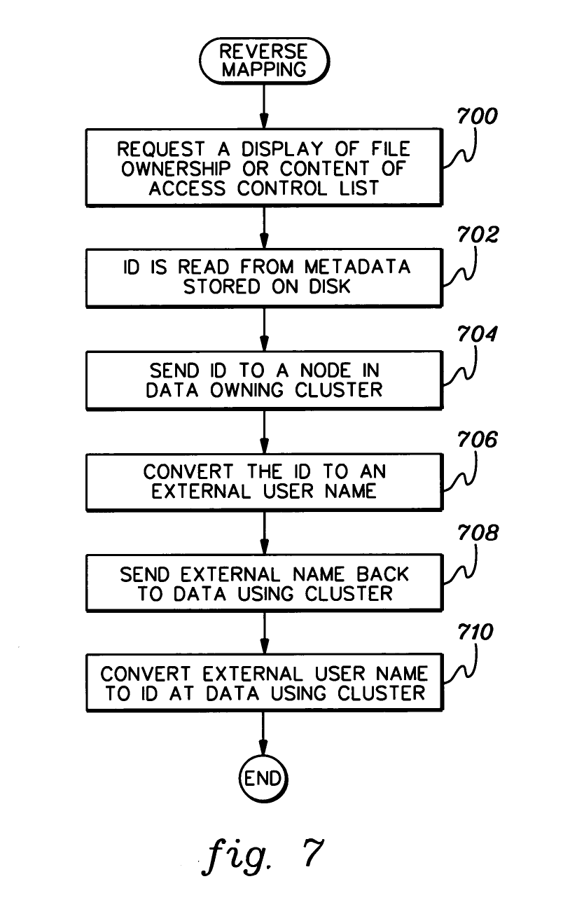

In addition to the above, it is possible to display file ownership or the content of access control lists by performing reverse mapping. One embodiment of the logic associated with reverse mapping is described with reference to FIG. 7. Initially, a user of a data using cluster requests a display of file ownership or a display of the contents of an access control list, STEP 700. In response to this request, code executing on a node of the data using cluster reads an identifier of a file, for instance, from the metadata stored on disk, STEP 702. This identifier refers to a user account in the file system data owning cluster. Thus, the identifier is sent to a node in the data owning cluster, STEP 704. The data owning cluster invokes an external mapping function to convert the identifier to an external user name, STEP 706. The external user name is then sent back to the data using cluster, STEP 708, which invokes the external mapping function to convert the external user name to a corresponding identifier at the data using cluster, STEP 710.

Similar to the mapping process, the reverse mapping is applicable to user identifiers, as well as to group identifiers. As described above, group identifiers may be mapped explicitly. With this technique, there are globally unique, external names, not only for users, but also for groups. The external mapping function maps between a local group identifier value and its external global name. In this case, each group identifier that appears in a processor's credentials is mapped individually in the same way as the processor's user identifier. For efficiency, the external mapping function should accept a list of user ids and group ids, so that a user's credentials can be converted in a single call. The message sent between a data using cluster and a data owning cluster for the purpose of user identifier mapping will then also include a list of user and group identifiers or names.

In addition to the above, group identifier may be implicitly mapped. For instance, if there is no infrastructure that defines global group names, group identifiers can be mapped implicitly as a side effect of the user identifier mapping. A user identifier is mapped by sending a message containing the user's external (or global) name to a node in the file system data owning cluster. For implicit group identifier mapping, the node sends a reply that also includes the group identifiers of all groups that the given user belongs to in the file system data owning cluster. The returned user identifier and group identifier list are then used in the user's credentials that are used for permission checking and file ownership decisions on the node of the data using cluster.

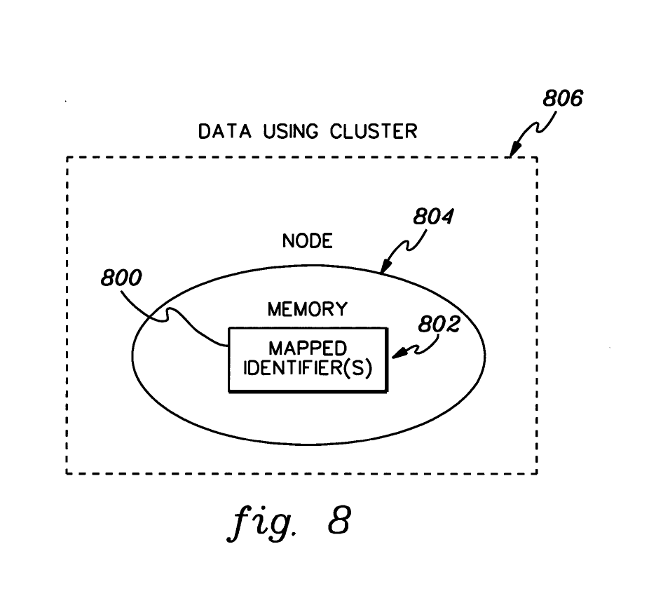

In accordance with a further aspect of the present invention, one or more mapped identifiers 800 (FIG. 8) (i.e., user identifiers and/or global identifiers of users having accounts on a data using cluster mapped to accounts of the users on a data owning cluster) are cached in memory 802 on a node 804 of the data using cluster 806, such that subsequent operations by the same user do not need to send additional messages. Cached identifier mappings are invalidated either via timeout or explicit command, as examples.

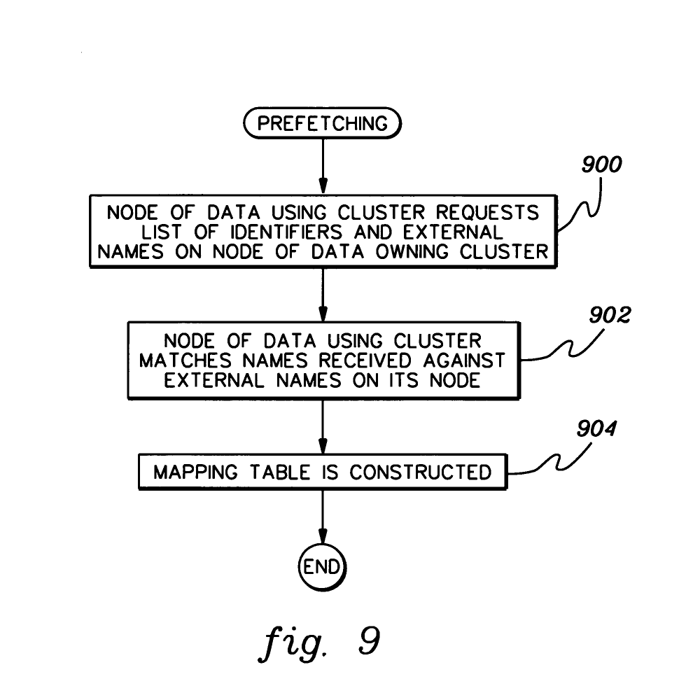

Moreover, for more efficient mapping of large numbers of identifiers, a prefetching capability is provided to prefetch identifier mappings. One embodiment of the logic associated with prefetching is described with reference to FIG. 9. As an example, a node of a data using cluster requests from a node of a data owning cluster a complete list of user identifiers/group identifiers and corresponding external names for the accounts of the data owning cluster, STEP 900. The requesting node then matches the external names it receives against external names for local accounts on the data using cluster, STEP 902. This allows the construction of a mapping table that maps identifiers of all users/groups that are known in both clusters, STEP 904. Thereafter, when a process accesses a file system in the data owning cluster, it can use the locally constructed mapping table, saving explicit calls to the external mapping function and messages to the file system data owning cluster.

Several variations to the above prefetching are also possible, including, for example, the following:
Instead of requesting the input for constructing a mapping table (list of external names and identifiers) from a node in the file system data owning cluster, the name/id list is stored in a special file in the file system itself.
Instead of each node separately constructing mapping tables for remote file systems, only one of the nodes in each cluster computes the mapping table and distributes the result to the other nodes in the cluster.
Instead of explicitly distributed mapping tables, the mapping tables are stored in the shared file system.

As in the case of mappings cached in memory, pre-computed mapping tables may be invalidated or refreshed either periodically or via explicit command, as examples.

In a further aspect of the present invention, incomplete mappings and unknown users are handled. For example, the mapping of the credentials of a user of a data using cluster may fail because that user does not have an account in the file system's data owning cluster. In this case, options are provided to either refuse that user access to the file system or to grant restricted access by mapping the external name of that user to a special user identifier for an unknown user.

As a further example, the reverse mapping (mapping an identifier from the file system data owning cluster to the id space of a data using cluster) may fail because a user or group with an account in the file system data owning cluster, who owns a file or appears in an access control list, may not have an account in all other clusters that have access to that file system. The program running in such a data using cluster will then not be able to display the file ownership or access control list in the same way as the local file system. For this scenario, three options are provided for handling such incomplete reverse mapping:
1) Map identifiers that cannot be mapped explicitly to a special identifier value that is displayed as “unknown use” or “unknown group”.
2) Map identifiers that cannot be mapped explicitly to a reserved range of identifiers that are not used for local user accounts. Most tools display such values in numerical form. This will convey more information than just “unknown user”; e.g., it is possible to tell whether two files have the same owner, even if the name of the owner is not known on the node of the data using cluster.
3) Do not do any reverse identifier mapping.

Each of these options can be augmented by providing customized tools for displaying and changing file ownership and access control lists, which the user can invoke instead of standard system tools (e.g., ls, chown, getalc). The customized tools are able to display external user/group names or user/group names as defined in the file system data owning cluster, regardless of whether those users/groups have local accounts in the cluster where the tool was invoked.

Described in detail above is a capability for providing mapped identifiers to facilitate access to data stored on shared storage media directly accessible by a plurality of independent clusters or other administrative domains. One or more aspects of the present invention enable GRID access to SAN file systems across separately administered domains.

Advantageously, one or more aspects of the present invention enable a user to have uniform access to its data (e.g., files of a file system) with the same permissions, regardless under which account the user is logged in. One or more aspects of the present invention provide the ability to use identifier substitution within the context of a global, shared disk file system dealing with the consistency of file system ownership structures, file system access lists, quotas and other file system structures. Identifier translation is provided to allow disk sharing. Since the node running the application accesses data and metadata directly on disk, mapping and permission checking is performed at the application node, which is a different administrative domain than the one managing the data.

Moreover, advantageously, user identifiers stored on shared disk are the user identifiers of the owners' account in the file system's owning cluster, regardless of where the program was running when the file was created. Similarly, user identifier values stored in access control lists (ACLs) granting file access to other users are user identifiers of these users' accounts in the file system owning cluster. Since permission checking is performed based on a user's user identifier, as an example, in the file system owning cluster, rather than the cluster, where the user's program is running, a user will be able to access files consistently with the same permissions, no matter where the user's program is running.

The capabilities of one or more aspects of the present invention can be implemented in software, firmware, hardware or some combination thereof.

One or more aspects of the present invention can be included in an article of manufacture (e.g., one or more computer program products) having, for instance, computer usable media. The media has therein, for instance, computer readable program code means or logic (e.g., instructions, code, commands, etc.) to provide and facilitate the capabilities of the present invention. The article of manufacture can be included as a part of a computer system or sold separately.

Additionally, at least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of facilitating access to data stored on shared storage media, said method comprising:
creating an identifier for a user with a first account in a first administrative domain and a second account in a second administrative domain, said identifier corresponding to the second account in the second administrative domain; and
using the identifier in the first administrative domain to access data managed by the second administrative domain, said data being stored on one or more shared storage media directly accessible by said first administrative domain and said second administrative domain.

2. The method of claim 1, wherein said creating comprises:
mapping on a node of the first administrative domain an identifier of the user corresponding to the first account to an external name;
forwarding the external name to a node of the second administrative domain; and
translating the external name to the identifier corresponding to the second account.

3. The method of claim 2, further comprising sending the identifier corresponding to the second account to a node of the first administrative domain for use in accessing data managed by the second administrative domain.

4. The method of claim 1, wherein the creating is performed in response to the user accessing a file system on the second administrative domain.

5. The method of claim 1, wherein said identifier comprises at least one of a user identifier and a group identifier associated with the user.

6. The method of claim 1, wherein said first administrative domain comprises a data using cluster and the second administrative domain comprises a data owning cluster.

7. The method of claim 1, further comprising caching the created identifier in memory of a node of the first administrative domain to be used in subsequent operations.

8. The method of clam 1, wherein the creating comprises using a mapping data structure to create the identifier, the mapping data structure being generated from a plurality of prefetched identifiers and corresponding external names.

9. The method of claim 1, further comprising determining at least one of an owner of data managed by the second administrative domain and a user having permission to access the data.

10. The method of claim 9, wherein the determining comprises:
reading a stored identifier from a shared storage medium storing said data;
forwarding the stored identifier to a node of the second administrative domain;
converting the stored identifier to an external name;
forwarding the external name to the first administrative domain; and
translating the external name to an identifier of the first administrative domain, said identifier identifying an account of the first administrative domain.

11. The method of claim 9, wherein the determining fails, and wherein the method further comprises handling the failing of the determining.

12. The method of claim 1, wherein the creating fails, and wherein the method further comprises handling the failing of the creating.

13. A system of facilitating access to data stored on shared storage media, said system comprising:
means for creating an identifier for a user with a first account in a first administrative domain and a second account in a second administrative domain, said identifier corresponding to the second account in the second administrative domain; and
means for using the identifier in the first administrative domain to access data managed by the second administrative domain, said data being stored on one or more shared storage media directly accessible by said first administrative domain and said second administrative domain.

14. The system of claim 13, wherein said means for creating comprises:
means for mapping on a node of the first administrative domain an identifier of the user corresponding to the first account to an external name;
means for forwarding the external name to a node of the second administrative domain;
means for translating the external name to the identifier corresponding to the second account; and
means for sending the identifier corresponding to the second account to a node of the first administrative domain for use in accessing data managed by the second administrative domain.

15. The system of claim 13, further comprising means for caching the created identifier in memory of a node of the first administrative domain to be used in subsequent operations.

16. The system of claim 13, further comprising means for determining at least one of an owner of data managed by the second administrative domain and a user having permission to access the data, wherein the means for determining comprises:
means for reading a stored identifier from a shared storage medium storing said data;
means for forwarding the stored identifier to a node of the second administrative domain;
means for converting the stored identifier to an external name;
means for forwarding the external name to the first administrative domain;
and
means for translating the external name to an identifier of the first administrative domain, said identifier identifying an account of the first administrative domain.

17. An article of manufacture comprising:
at least one computer usable medium having computer readable program code logic to facilitate access to data stored on shared storage media, the computer readable program code logic comprising:
create logic to create an identifier for a user with a first account in a first administrative domain and a second account in a second administrative domain, said identifier corresponding to the second account in the second administrative domain; and
use logic to use the identifier in the first administrative domain to access data managed by the second administrative domain, said data being stored on one or more shared storage media directly accessible by said first administrative domain and said second administrative domain.

18. The article of manufacture of claim 17, wherein said create logic comprises:
map logic to map on a node of the first administrative domain an identifier of the user corresponding to the first account to an external name;
forward logic to forward the external name to a node of the second administrative domain;
translate logic to translate the external name to the identifier corresponding to the second account; and
send logic to send the identifier corresponding to the second account to a node of the first administrative domain for use in accessing data managed by the second administrative domain.

19. The article of manufacture of clam 17, wherein the create logic comprises use logic to use a mapping data structure to create the identifier, the mapping data structure being generated from a plurality of prefetched identifiers and corresponding external names.

20. The article of manufacture of claim 17, further comprising determine logic to determine at least one of an owner of data managed by the second administrative domain and a user having permission to access the data, wherein the determine logic comprises:
read logic to read a stored identifier from a shared storage medium storing said data;
forward logic to forward the stored identifier to a node of the second administrative domain;
convert logic to convert the stored identifier to an external name;
forward logic to forward the external name to the first administrative domain; and
translate logic to translate the external name to an identifier of the first administrative domain, said identifier identifying an account of the first administrative domain.
